(19) United States
(12) Patent Application Publication
(10) Pub. No.: US 2023/0387443 A1
(43) Pub. Date: Nov. 30, 2023

(54) Fuel Cell Assemblies with Improved Contact Pressure Distribution

(71) Applicant: Loop Energy Inc., Burnaby (CA)

(72) Inventors: Matthew Guenther, Vancouver (CA); David Erwin Kadylak, Surrey (CA); Sean Michael MacKinnon, Gibsons (CA); Andrea Pulskamp, North Vancouver (CA); Matthew Paul Paone, Burnaby (CA)

(21) Appl. No.: 18/313,119

(22) Filed: May 5, 2023

Related U.S. Application Data
(63) Continuation of application No. PCT/CA2021/051575, filed on Nov. 4, 2021.
(60) Provisional application No. 63/110,379, filed on Nov. 6, 2020.

(51) Int. Cl. H01M 8/248; H01M 8/0265; H01M 8/1004

(52) U.S. Cl. CPC H01M 8/248; H01M 2008/1095; H01M 8/1004; H01M 8/0265

(57) ABSTRACT

The present technology relates to apparatus and methods for providing contact pressure distribution between fuel cell components in a fuel cell stack. In some embodiments, the technology relates to fuel cell flow field plate designs and to compression systems for fuel cell stacks that can be used, separately or in combination, to provide more uniform contact pressure distribution across the active area of fuel cells in a fuel cell stack.

### CROSS-REFERENCE TO RELATED APPLICATION(S)

This application is a continuation of International Application No. PCT/CA2021/051575 having an international filing date of Nov. 4, 2021 entitled “Fuel Cell Assemblies with Improved Contact Pressure Distribution”. The '575 application is related to and claimed priority benefits from U.S. Provisional Patent Application Ser. No. 63/110,379 having a filing date of Nov. 6, 2020, entitled “Fuel Cell Assemblies with Improved Contact Pressure Distribution”.

The present application claims priority to the '379 and '575 applications which are hereby incorporated by reference herein in their entireties.

### FIELD OF THE INVENTION

The present technology relates to apparatuses and methods for providing favorable contact pressure distribution between fuel cell components in a fuel cell stack. In particular, the technology relates to fuel cell flow field plate designs and to compression systems for fuel cell stacks that can be used, separately or in combination, to provide, at least in some embodiments, more uniform contact pressure distribution across the active area of fuel cells in a fuel cell stack.

Solid polymer fuel cells are electrochemical devices that produce electrical power and water from a fuel, such as hydrogen and oxygen. An individual solid polymer fuel cell comprises an ion exchange membrane electrolyte separating an anode and a cathode, the anode and cathode comprising a catalyst layer. The anode-electrolyte-cathode is typically interposed between a pair of electrically conductive reactant flow field plates that collect current, facilitate the access of the fuel and oxidant to the anode and cathode catalyst layer, respectively, and provide for the removal of water formed during the operation of the fuel cell. In addition to facilitating distribution of reactants to the fuel cell electrodes, and removal of water produced from individual cells in a stack, the flow field plates also assist with thermal management (cooling) and electrical current collection.

Flow field plates generally include one or more open-faced channels on one or both of their major surfaces. These channels typically extend between an inlet and an outlet, although other arrangements, such as interdigitated channels are sometimes used. Typically, a porous, compressible fluid distribution layer, referred to herein as a gas diffusion layer (GDL), is interposed between the flow field plate and the respective electrode, and the reactants access the catalyst layer from the channels in the plates via the porous GDL. The membrane, anode and cathode catalyst layers and a pair of GDLs are often combined to form a membrane electrode assembly (MEA) which is then placed between a pair of flow field plates to form an individual fuel cell assembly.

A plurality of fuel cell assemblies can be arranged to form a fuel cell stack. A compression assembly is typically used to hold the fuel cells in a stacked arrangement, and to apply compressive force to provide suitable contact between the stacked components and to compress seals and/or gaskets used to prevent leakage of fluids from the stack or between the anodes and cathodes.

In conventional fuel cell flow field plates, within the active area the reactant channels typically have a constant width (and cross-sectional area) along their length. The landings, which are the ribs or regions in between the channels (or segments of channels) on a flow field plate, typically also have a constant width. This is generally the case for fuel cells with straight channels and also for fuel cells having serpentine channels. Sometimes there is a transition region on the flow field plates (e.g. between the inlet and outlet manifold openings, or inlet and outlet ports, and the rest of the flow field).

Improved fuels cells, such as those described in U.S. Pat. Nos. 7,838,769 and 10,686,199 can have flow field plates with reactant channels having cross-sectional areas that vary along at least a portion of the channel length between an inlet and an outlet. Fuel cells that incorporate reactant channels with varying cross-sectional areas can provide several advantages over traditional fuel cell flow fields including, for example, providing more uniform current density, enhancing performance by increasing overall current density, and/or improved water management and reactant availability across the active area. In some fuel cells having flow field plates with reactant channels having cross-sectional areas that vary along at least a portion of the channel length between the inlet and the outlet, it is the channel width that varies.

In designing fuel cell flow field plates, the selection of the channel dimensions and channel geometry can be important. For example, the spacing, dimensions and geometry of the channels and the dimensions and geometry of the landings between the channels affects fuel cell performance and durability. The landing areas are the regions on the surface of the flow field plate that are in contact with the adjacent GDL. These landing areas can be important for electrical current collection and thermal management (e.g. conduction of heat from the fuel cell MEAs to the coolant which is typically flowing in contact with the back face of the flow field plates). Low contact pressure between the landing areas of the flow field plates and the GDL can be undesirable because it increases the electrical contact resistance and thermal contact resistance between these components. On the other hand, high contact pressure between the landing areas and the GDL can compact and reduce the porosity of the GDL and thereby hinder reactant access and water removal through the GDL. It can also damage or cause mechanical failure of the GDL or MEA, and/or cause the GDL to intrude into the flow channels which can adversely increase pressure drop along the channel. Thus, there are trade-offs to be made in selecting the compression force that is applied to the fuel cells in a fuel cell stack because, among other things, it can influence the contact pressure between the landing areas and the GDL.

### SUMMARY OF THE INVENTION

In some embodiments, a fuel cell assembly comprises at least one unit cell, where the unit cell comprises a membrane electrode assembly comprising a proton exchange membrane interposed between a first electrode and a second electrode. In some embodiments, the first electrode comprises a first gas diffusion layer and a first catalyst layer, and the second electrode comprises a second gas diffusion layer and a second catalyst layer. In some embodiments, the first and second catalyst layers define an active area of the unit cell. In some embodiments, the unit cell further comprises a first flow field plate adjacent to the first gas diffusion electrode and a second flow field plate adjacent to the second electrode. In some embodiments, the first flow field plate has a first surface adjacent to the first gas diffusion layer, and the first flow field plate comprises a plurality of first channels formed in the first surface thereof. Adjacent ones of the first channels are separated by landings.

In some embodiments of a fuel cell assembly, the first channels have a first channel length, and a width that varies along at least a portion of the first channel length. If or when a substantially uniform compressive force is applied to the unit cell to urge the first and second flow field plates toward one another, a contact pressure between the first gas diffusion layer and the landings of the first flow field plate is substantially uniform across the active area of the unit cell. In some embodiments, the contact pressure between the first gas diffusion layer and the landings of the first flow field plate is substantially uniform when the fuel cell assembly is in a non-operating state, for example, prior to operation and/or when it is non-pressurized and/or not being supplied with reactants. In some embodiments, the contact pressure between the first gas diffusion layer and the landings of the first flow field plate is substantially uniform during operation of the fuel cell assembly to generate electrical power, for example, when the fuel cell is being supplied with reactants and is connected to an electrical load.

In some embodiments of the first aspects of a fuel cell assembly, a landing-channel width ratio (LCWR) is substantially constant along the first channel length. In some embodiments a landing area fraction (LAF) on the first surface of the first flow field plate is substantially uniform across the active area of the unit cell. In some embodiments, the second flow field plate has a first surface adjacent to the second gas diffusion layer, and the second flow field plate comprises a plurality of second channels formed in the first surface thereof. Adjacent ones of the second channels are separated by landings, and the second channels have a second channel length. In some embodiments the second channels have a width that varies along at least a portion of the second channel length and, when the substantially uniform compressive force is applied to the unit cell to urge the first and second flow field plates toward one another, a contact pressure between the second gas diffusion layer and the landings of the second flow field plate is substantially uniform across the active area of the unit cell.

In some embodiments of the first aspects of a fuel cell assembly, the first channels have a width that varies along the entire length of the first channels. In some embodiments, the first channels have a width that decreases along at least a portion of the first channel length, or along their entire length, in a direction of reactant flow. In some embodiments, the first channels have a width that decreases along at least a portion of the first channel length, or along their entire length, in a direction of reactant flow according to a natural exponential function.

In some embodiments of the first aspects of a fuel cell assembly, the fuel cell assembly comprises a fuel cell stack comprising a plurality of unit cells.

In second aspects of a fuel cell assembly, the first channels have a first channel length, and a width that varies along at least a portion of the first channel length, and the fuel cell assembly further comprises a compression system urging the first and second flow field plates toward one another and applying non-uniform compressive force across the active area of the unit cell, wherein a contact pressure between the first gas diffusion layer and the landings of the first flow field plate is substantially uniform across the active area of the unit cell. In some embodiments, the contact pressure between the first gas diffusion layer and the landings of the first flow field plate is substantially uniform when the fuel cell assembly is in a non-operating state, for example, prior to operation and/or when it is non-pressurized and/or not being supplied with reactants. In some embodiments, the contact pressure between the first gas diffusion layer and the landings of the first flow field plate is substantially uniform during operation of the fuel cell assembly to generate electrical power, for example, when the fuel cell is being supplied with reactants and is connected to an electrical load.

In some embodiments of a fuel cell assembly, a landing-channel width ratio (LCWR) varies along at least a portion of the first channel length. In some embodiments, a landing area fraction (LAF) on the first surface of the first flow field plate varies across the active area of the unit cell. In some embodiments, the second flow field plate has a first surface adjacent to the second gas diffusion layer, and the second flow field plate comprises a plurality of second channels formed in the first surface thereof, adjacent ones of the second channels separated by landings, the second channels having a second channel length, and the second channels having a width that varies along at least a portion of the second channel length, and a contact pressure between the second gas diffusion layer and the landings of the second flow field plate is substantially uniform across the active area of the unit cell.

In some embodiments of a fuel cell assembly, the first channels have a width that varies along the entire length of the first channels. In some embodiments, the first channels have a width that decreases along at least a portion of the first channel length, or along their entire length, in a direction of reactant flow. In some embodiments, the first channels have a width that decreases along at least a portion of the first channel length, or along their entire length, in a direction of reactant flow according to a natural exponential function.

In some embodiments of a fuel cell assembly, the fuel cell assembly comprises a fuel cell stack comprising a plurality of unit cells. In some such embodiments, the compression system comprises a pair of end-plate assemblies, with the fuel cell stack interposed between them, wherein at least one of the end-plate assemblies comprises a plurality of plate segments positioned side-by-side at one end of the fuel cell stack. In some embodiments, each of the plurality of plate segments can comprise a spring set with a different force-displacement characteristic, each of the segments and its associated spring set exerting a different compressive force on the fuel cell stack. In some embodiments, the compression system comprises first and second end-plate assemblies and a first spring assembly and a second spring assembly positioned side-by-side and interposed between the first end-plate assembly and the fuel cell stack, the first spring assembly overlying a first portion of the active area of the unit cells and the second spring assembly overlying a second portion of the active area of the unit cells, wherein the first spring assembly has a different force-displacement characteristic from the second spring assembly.

In some embodiments a fuel cell assembly, the fuel cell assembly further comprises a compression system urging the first and second flow field plates toward one another and applying a non-uniform compressive force across the active area of the unit cell during operation of the fuel cell assembly to produce electrical power, wherein a contact pressure between the first gas diffusion layer and the landings of the first flow field plate is substantially uniform across the active area of the unit cell during operation of the fuel cell assembly. The non-uniform compressive force can compensate for variations in contact pressure that are caused, for example, by non-uniform reactant stream pressures across the active area of the fuel cells.

In some embodiments of a fuel cell assembly, the first channels have a width that varies along the entire length of the first channels. In some embodiments, the first channels have a width that decreases along at least a portion of the first channel length, or along their entire length, in a direction of reactant flow. In some embodiments, the first channels have a width that decreases along at least a portion of the first channel length, or along their entire length, in a direction of reactant flow according to a natural exponential function.

In some embodiments of a fuel cell assembly, the fuel cell assembly comprises a fuel cell stack comprising a plurality of unit cells. In some such embodiments, the compression system comprises a pair of end-plate assemblies, with the fuel cell stack interposed between them, wherein at least one of the end-plate assemblies comprises a plurality of plate segments positioned side-by-side at one end of the fuel cell stack wherein each of the plurality of plate segments comprises a spring set with a different force-displacement characteristic, each of the segments and its associated spring set exerting a different compressive force on the fuel cell stack. In some embodiments, each of the plurality of plate segments can comprise a spring set with a different force-displacement characteristic, each of the segments and its associated spring set exerting a different compressive force on the fuel cell stack. In some embodiments, the compression system comprises first and second end-plate assemblies and a first spring assembly and a second spring assembly positioned side-by-side and interposed between the first end-plate assembly and the fuel cell stack, the first spring assembly overlying a first portion of the active area of the unit cells and the second spring assembly overlying a second portion of the active area of the unit cells, wherein the first spring assembly has a different force-displacement characteristic from the second spring assembly.

In some embodiments of a fuel cell assembly, the fuel cell active area is non-rectangular. In some such embodiments, the active area is trapezoidal.

A method for reducing contact pressure variation between components in a solid polymer fuel cell assembly during operation of the fuel cell assembly to produce electrical power, can comprise applying a non-uniform compressive force across the active area of the fuel cell assembly to at least partially compensate for variations in contact pressure caused by operation of the fuel cell assembly.

### BRIEF DESCRIPTION OF THE DRAWINGS

FIG. 1 is an exploded perspective view of a fuel cell stack.

FIG. 2 is an exploded cross-sectional view of a fuel cell assembly.

FIG. 3A is a top view of a fuel cell flow field plate.

FIG. 3B is a top view of a fuel cell flow field plate.

FIG. 3C is a top view of a fuel cell flow field plate.

FIGS. 4A-4C are cross-sectional views at three positions of a fuel cell with Flow Field A, illustrating variation in the channel and landing widths near the inlet, near the outlet and near the middle.

FIGS. 5A-5C are cross-sectional views at three positions of a fuel cell with Flow Field B, illustrating variation in the channel and landing widths near the inlet, near the outlet and near the middle.

FIGS. 6A-6C are cross-sectional views at three positions of a fuel cell with Flow Field C, illustrating variation in the channel and landing widths near the inlet, near the outlet and near the middle.

FIGS. 7A-7C are cross-sectional views at three positions of a fuel cell with Flow Field D, illustrating variation in the channel and landing widths near the inlet, near the outlet and near the middle.

FIG. 8 is a graph illustrating channel width and landing width as a function of normalized channel length for Flow Field A.

FIG. 9 is a graph illustrating landing width as a function of normalized adjacent channel length for Flow Fields A-D.

FIG. 10 is a graph illustrating landing-channel width ratio (LCWR) as a function of normalized adjacent channel length for Flow Fields A-D and a conventional flow field.

FIG. 11 is a graph illustrating contact pressure on the landing as a function of normalized adjacent channel length for Flow Fields A-D and a conventional flow field.

FIG. 12 is a graph illustrating landing activity ratio as a function of normalized adjacent channel length for Flow Fields A-D.

FIG. 13 is a graph illustrating landing electrical contact resistance as a function of normalized adjacent channel length for Flow Fields A-D and a conventional flow field.

FIG. 14A is a graph illustrating GDL electrical contact resistance as a function of compression.

FIG. 14B is a graph illustrating compression as a function of normalized compressed GDL thickness.

FIG. 15A is a graph illustrating spring load as a function of distance traveled for a spring.

FIG. 15B is a graph illustrating spring load as a function of distance traveled for another spring.

FIG. 16A is an exploded perspective view of a fuel cell stack assembly utilizing tension rods and washers and end-plates to apply compressive force to a fuel stack.

FIG. 16B is a perspective view of the assembled fuel cell stack assembly of FIG. 16A.

FIG. 16C is an exploded perspective view of a fuel cell stack assembly utilizing end-plates, disc springs and straps to apply compressive force to a fuel stack.

FIG. 17 is a perspective partial cross-sectional view of a fuel cell stack assembly utilizing a piston to provide compressive force to a fuel stack.

FIG. 18 is a cutaway view of a wedge-shaped gas diffusion layer varying down the length of the flow field.

FIG. 19 is a graph illustrating the performance of a fuel cell stack comprising fuel cells with Flow Field A with the performance of a fuel cell stack comprising fuel cells with Flow Field D.

### DETAILED DESCRIPTION OF ILLUSTRATIVE EMBODIMENT(S)

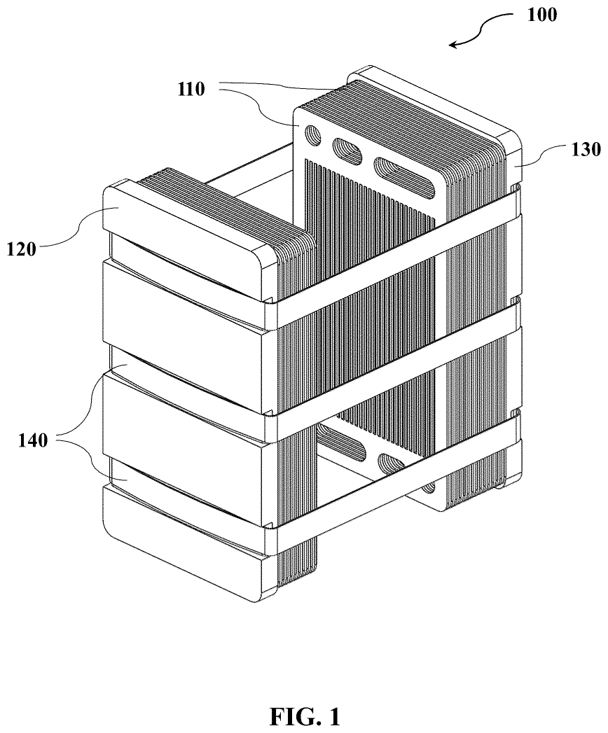

FIG. 1 shows fuel stack 100 comprising a plurality of individual fuel cell assemblies stacked between a pair of end-plates 120 and 130. In some embodiments, disc spring(s) (not visible in FIG. 1) and strap 140 are used to hold end-plates 120 and 130 in position and to urge them toward one another to apply compressive force on plurality of fuel cells 110. In some embodiments, other types of compression systems can be used in fuel cell stacks, such as but not limited to, tie-rods, hydraulic systems, and/or clamps.

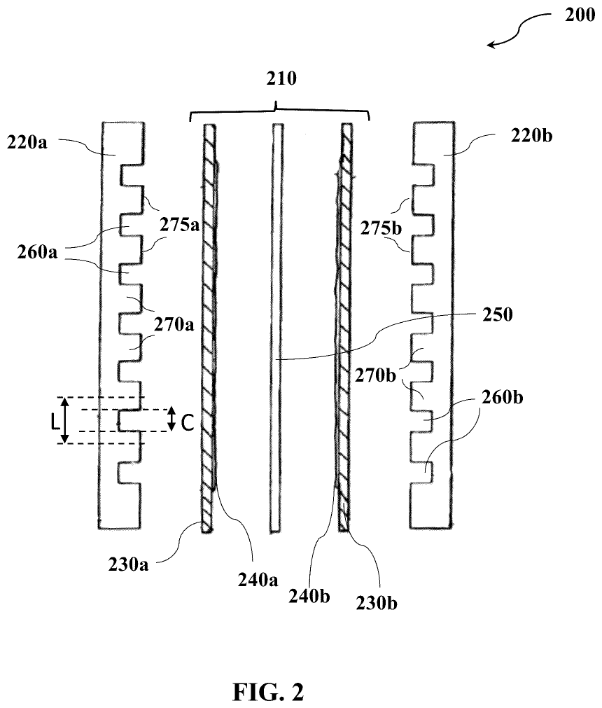

FIG. 2 shows a simplified exploded cross-sectional view of an individual fuel cell 200 with an membrane electrode assembly (MEA) 210 interposed between a pair of flow field plates 220a and 220b. MEA comprises a membrane-electrolyte sandwich, with a membrane electrolyte 250 and gas diffusion layer (GDL) 230a on the anode side with an anode catalyst layer 240a interposed between GDL 230a and membrane 250, and another GDL 230b on the cathode side with a cathode catalyst layer 240b interposed between GDL 230b and membrane 250. In some methods of manufacturing a fuel cell, the catalyst layers are deposited on the membrane. In some methods of manufacturing, the catalyst layers are deposited on the GDL. Flow field plates 220a and 220b have channels (260a and 260b, respectively) formed therein, for directing fuel and oxidant to the respective GDL and catalyst layers. Landings 270a and 270b separate the channels on each of the plates, and surfaces 275a and 275b of the respective landings contact the adjacent GDL when fuel cell 200 is assembled together and/or compressive force is applied perpendicular to the plane of the components.

In many fuel cells and fuel cell stacks, coolant channels are also provided for delivery or circulation of a coolant fluid such as water or air for thermal management of the operating fuel cell or fuel cell stack. Coolant channels can be provided, for example, on the back of the anode or cathode flow field plates (in other words, on the opposite face to the reactant channels), or in separate coolant flow field plates interposed between adjacent fuel cells in a stack.

### Landing Area Fraction (LAF) and Landing-Channel Width Ratio (LCWR)

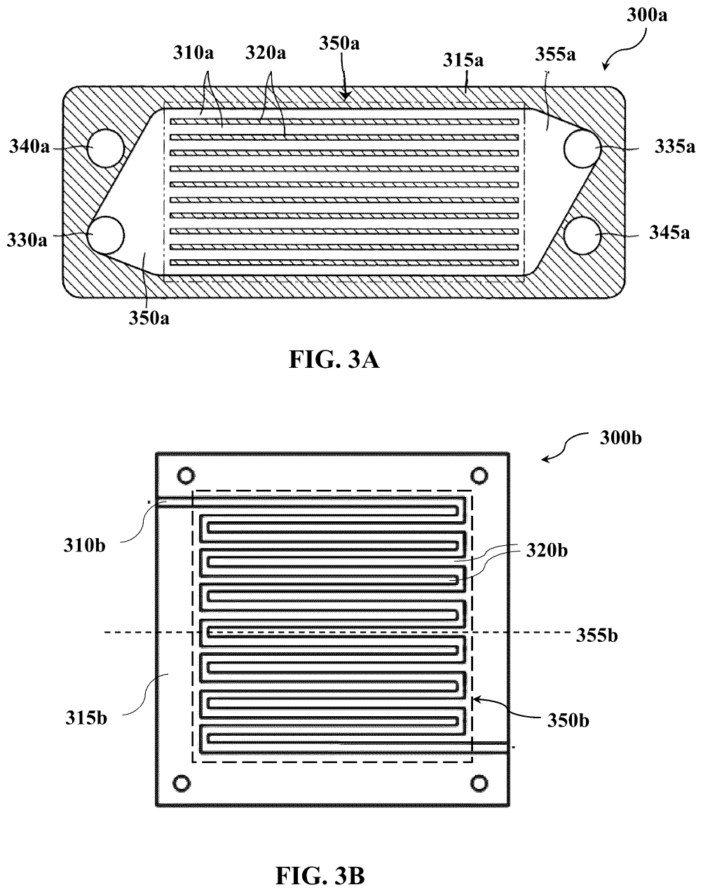

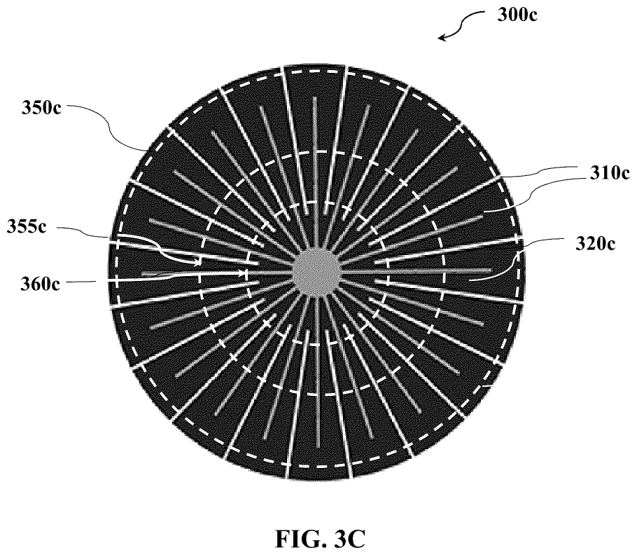

FIG. 3A is a plan view of a fuel cell flow field plate 300a showing a plurality of channels 310a separated by landings 320a and surrounded by a border region 315a. The channels extend between inlet region 350a and outlet region 355a with fluid (e.g. reactant) supplied via inlet manifold opening 330a and discharged via outlet manifold opening 335a. Additional manifold openings 340a and 345a can be provided in flow field plate 300a, for example, for supply and discharge of fluid to and from channels on the opposite surface of flow field plate 300a. The channels can be formed in the flow field plate by suitable methods, such as for example stamping, embossing, molding, machining, etc. depending on the material of the plate.

The landing area fraction (or LAF) over a particular region of the plate can be defined as: the ratio of [the surface area of the landings] to [the total area (landing surface area and open-channel area at the surface of the plate)] within that particular region of the plate.

$$Landing Area Fraction = \frac{( surface area of landing ( s ) )}{( total landing + channel area )}$$

For example, the LAF fraction can be calculated or otherwise determined over the active area of a flow field plate in a particular fuel cell. The active area can be defined as the region of the flow field plate that overlies the catalyst layer of the adjacent electrode in the fuel cell. For example, in FIG. 3A the LAF could be determined for the region marked 350a. In this example, the LAF over region 350a (indicated by a dashed outline) is approximately the ratio of [the width of a landing 320a] to [the width of a landing 320a plus the width of a channel 310a]. The LAF fraction can also be calculated or otherwise determined over the entire area of a flow field plate, in which case the landing area would include all of the surface area of the plate that would contact the GDL (e.g. including border regions around the flow field).

For a given applied compressive force (for example, a force applied by the compression mechanism in a fuel cell stack), the contact pressure between the flow field plate and the adjacent GDL is generally higher for plates having a lower LAF across their entire area, because the compressive force is transmitted to the GDL over a smaller contact area than for a plate that has a higher LAF.

For flow field plate 300a shown in FIG. 3A, the LAF is substantially uniform across region 350a indicated by a dashed outline. FIG. 3B is a plan view of another flow field plate 300b with a serpentine channel 310b where the sweeps of the channel are separated by landings 320b, and a border region 315b surrounds flow field region 350b (indicated by a dashed outline). Again, the LAF across region 350b of flow field plate 300b is substantially uniform. For example, the LAF in the portion of region 350b above dashed line 355b is the approximately the same as the LAF in the portion of region 350b below dashed line 355b.

In some flow field plates, the LAF can vary across the plate, or across the active area or a flow field region of the plate. For example, LAF can vary across the active area between the reactant inlet and outlet. FIG. 3C. is a plan view of a (known) circular flow field plate 300c with radial interdigitated inlet and outlet channels 310c of constant width, and landings 320c between the channels. It can be seen that the LAF in an outer annular region of flow field plate 300c between white dashed circles 350c and 355c, is greater than in an annular region between white dashed circles 355c and 360c.

A landing-channel width ratio (LCWR) can also be defined at each position along the length of each channel in a flow field plate, for example, from an inlet to an outlet. The LCWR at a particular point along a channel can be defined as:

$$LCWR = \frac{( dis tance between centres of on either side landings of channel minus channel width )}{( d i s tance between centres of landings on either side of channel )}$$

The distances are measured perpendicular to the direction of the channel at that position along the channel. For example, for the channels 260a in the cross-sectional drawing shown in FIG. 2:

$$LCWR = \frac{( L - C )}{L}$$

Referring to FIGS. 3A and 3B, the LCWR in these flow field plates remains substantially constant along the length of channels 310a and 310b, respectively. For the flow field plate illustrated in FIG. 3C, the LCWR decreases along each of the channels as they are traversed towards the center of plate 300c; the channels have constant width, but the landing widths are getting narrower.

### Flow Field Plate Design

In designing fuel cell flow field plates, the selection of the channel dimensions and channel geometry is important. Consideration should be given to the spacing, dimensions and geometry of the channels and the dimensions and geometry of the landings between the channels, and to the effect these parameters (and the overall fuel cell shape and architecture) have on contact pressure distribution across the fuel cell active area. In at least some embodiments, the landing areas are important for electrical current collection and thermal management. As noted above, in at least some embodiments, low contact pressure between the landing areas of the flow field plates and the GDL can be undesirable because it increases the electrical contact resistance and thermal contact resistance between these components. High contact pressure between the landing areas and the GDL can compact and reduce the porosity of the GDL, and thereby hinder reactant access and water removal through the GDL. It can also damage or cause mechanical failure of the GDL or MEA, and/or cause the GDL to intrude into the flow channels which can adversely increase pressure drop along the channel. Thus, there are trade-offs to be made in selecting the compression force that is applied to the fuel cells in a fuel cell stack because, among other things, it influence s the contact pressure between the landing areas and the GDL.

The flow field design, and the overall fuel cell shape and architecture, can also influence the contact pressure distribution (the variation in contact pressure) across the fuel cell active area. For example, if the width of the landings varies across a flow field plate, this can lead to areas of low and high contact pressure. For example, the contact pressure between the plate and GDL can be lower where the landings are wider and higher where the landings are narrower. These variations in local contact pressure affect things like electrical and thermal contact resistance, and compaction of the GDL, as noted above. A high variation in contact pressure across the active area can be undesirable.

The width of the landing can affect other things related to fuel cell performance. Although a wider landing can provide a larger contact area between the plate and GDL for current collection and heat removal, and is less likely to damage the MEA, it can inhibit the ability of the reactant to reach portions of a catalyst layer that lies beneath the center of a wide landing.

In fuel cells where the width of the channels varies along at least a portion of the channel length, it can be challenging to provide favorable contact pressure distribution across the active area of the fuel cells.

For example, in fuel cells where the width of the channels decreases toward the outlet along the channel length, keeping the channel spacing between adjacent channels the same (i.e. so that the center-lines of adjacent channels remain a fixed distance apart) results in landings that get wider toward the outlet. If the landing widths are constant then the channels converge, and if the LCWR is held substantially constant then the channels converge even more.

In fuel cells, where the channel width decreases in an exponential manner it can be impractical to maintain a constant LCWR along the channels while keeping the channel or landing spacing constant or changing the spacing in a linear manner along their length. For example, in embodiments where the channel width decreases in an exponential manner and the LCWR is the same at the outlet of the channel as at the inlet, the landing width increases at least slightly between the inlet and the outlet.

Sometimes, in fuel cells where the width of the channels and/or landings varies along at least a portion of the channel length, non-rectangular flow field plates are used, for example, circular flow field plates with radial channels/landings, isosceles trapezoidal plates or trapezoidal plates where only two sides of the plate have the same length. It can be challenging to provide favorable contact pressure distribution across the active area of such plates, due to their shape.

Landing-to-landing alignment across the MEA is also a consideration. If landings from neighboring plates on opposite faces of the MEA do not have sufficient overlap, they can nest into each other and mechanically fracture the MEA.

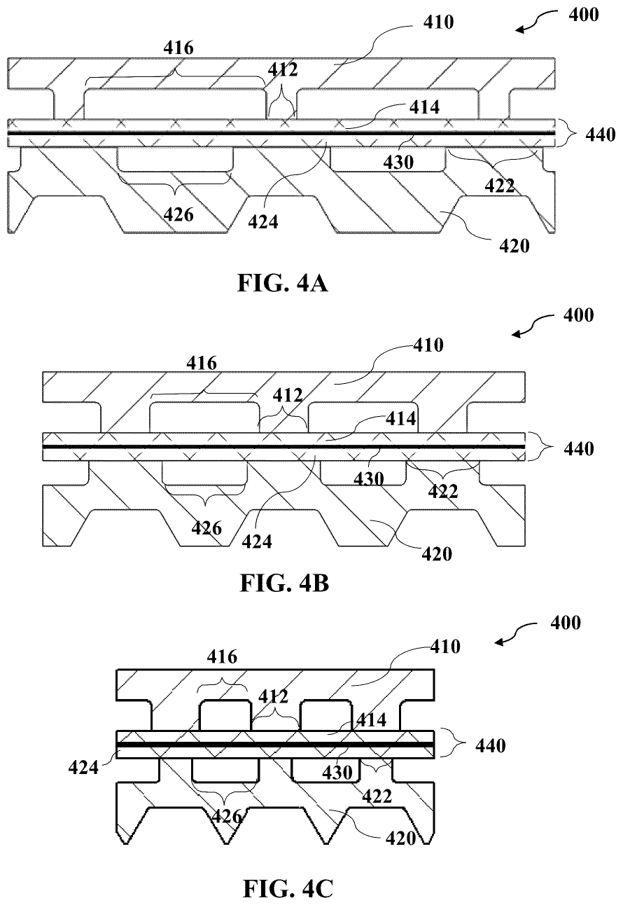

FIGS. 4A-7C illustrate flow field plates with four different flow fields on the upper plates: Flow Field A, Flow Field B, Flow Field C, and Flow Field D. The flow fields illustrated in FIGS. 4A-7C have channels that extend across a surface of the flow field plate directly from an inlet to an outlet. In all four of these examples, the channels decrease in width from the inlet to the outlet, and the channels converge from inlet to outlet. In Flow Field A the landing widths increase from inlet to outlet, whereas in Flow Field B-D the landing widths decrease from inlet to outlet.

Aspects of the approaches, technologies, flow field design considerations and improvements to fuel cell and fuel cell stack designs described herein can also be applied to fuel cells comprising other types of flow fields and flow field channels. For example, they can be applied to fuel cells where the flow field comprises channels that vary in width along the entire channel length, just along a portion of the channel length and/or along several portions of the channel length. The variation in width can be, for example, linear, exponential or stepwise, and in any direction. The channels can be, for example, straight, wavy, serpentine and in some embodiments, can be interdigitated.

FIGS. 4A, 4B and 4C are cross-sectional views of a portion of a fuel cell 400 having a Flow Field A on the upper flow field plate. Fuel cell 400 includes a membrane electrode assembly 440 interposed between a first (upper) flow field plate 410 and a second (lower) flow field plate 420. Membrane electrode assembly 440 includes ion exchange membrane 430 interposed between two electrodes, 414 and 424. First flow field plate 410 has a plurality of landings with landing width 412 and channels width 416, and second flow field plate 420 has a plurality of landings with width 422 and channels with width 426.

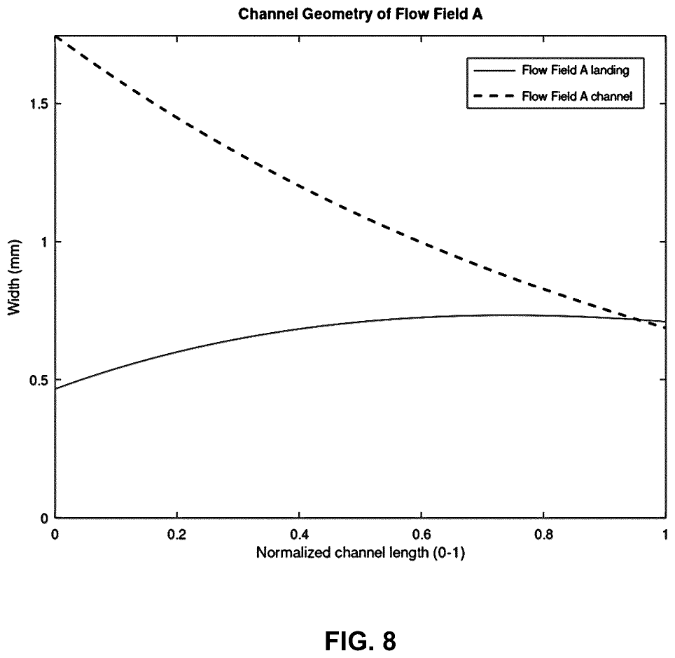

FIG. 4A, shows a cross-section of fuel cell 400 near the inlet. FIG. 4B, shows a cross-section of fuel cell 400 near the middle. FIG. 4C, shows a cross-section of fuel cell 400 near the outlet. As is apparent from these illustrations, on the first plate 410 the channel width 416 decreases from the inlet to the middle, and again from the middle to the outlet. The landing width 412 increases from the inlet to the middle and is almost unchanged between the middle and the outlet. The variation of channel width 416 and landing width 412 along the channel length (normalized) for first (upper) flow field plate 410 is shown in FIG. 8.

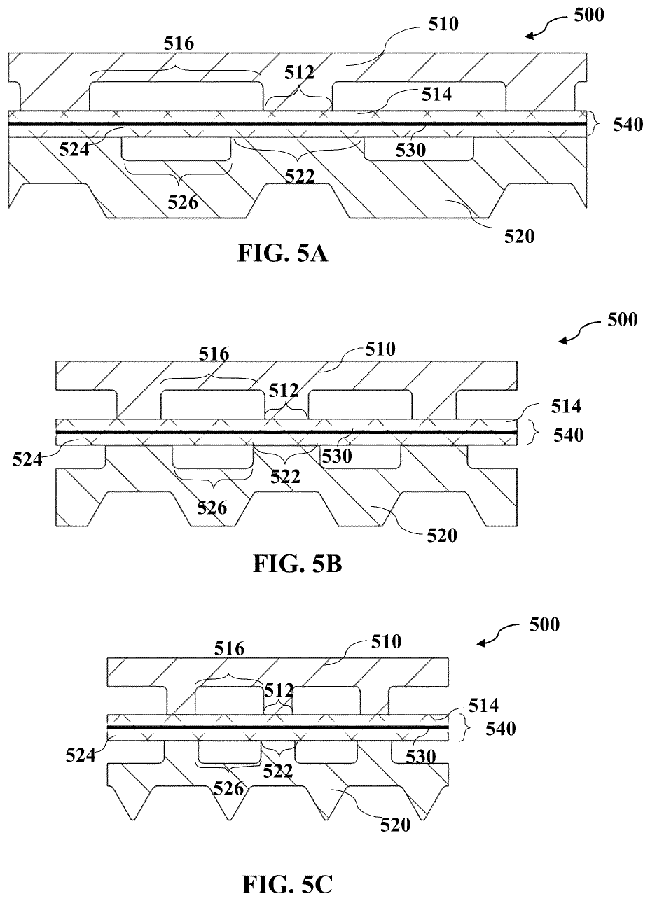

FIGS. 5A, 5B and 5C are cross-sectional views of a portion of a fuel cell 500 having a Flow Field B on the upper flow field plate. Fuel cell 500 includes a membrane electrode assembly 540 interposed between a first (upper) flow field plate 510 and a second (lower) flow field plate 520. Membrane electrode assembly 540 includes ion exchange membrane 530 interposed between two electrodes, 514 and 524. First flow field plate 510 has a plurality of landings with width 512 and channels width 516, and second flow field plate 520 has a plurality of landings with width 522 and channels with width 526.

FIG. 5A, shows a cross-section of fuel cell 500 near the inlet. FIG. 5B, shows a cross-section of fuel cell 500 near the middle. FIG. 5C, shows a cross-section of fuel cell 500 near the outlet. As is apparent from these illustrations, on the first flow field plate 510 the channel width 516 and the landing width 512 decreases from the inlet to middle, and again from the middle to the outlet.

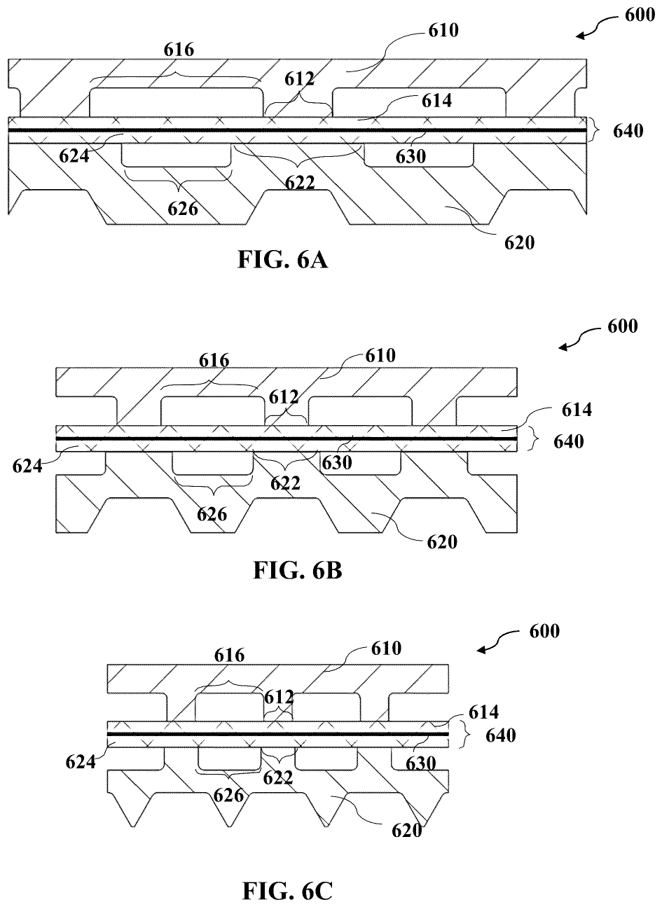

FIGS. 6A, 6B and 6C are cross-sectional views of a portion of a fuel cell 600 having a Flow Field C on the upper flow field plate. Fuel cell 600 includes a membrane electrode assembly 640 interposed between a first (upper) flow field plate 610 and a second (lower) flow field plate 620. Membrane electrode assembly 640 includes ion exchange membrane 630 interposed between two electrodes, 614 and 624. First flow field plate 610 has a plurality of landings with landing width 612 and channels width 616, and second flow field plate 620 has a plurality of landings with width 622 and channels with width 626.

FIG. 6A, shows a cross-section of fuel cell 600 near the inlet. FIG. 6B, shows a cross-section of fuel cell 600 near the middle. FIG. 6C, shows a cross-section of fuel cell 600 near the outlet. As is apparent from these illustrations, on the first flow field plate 610 the channel width 616 decreases from the inlet to middle, and again from the middle to the outlet. As is apparent from these illustrations, on the first flow field plate 610 the channel width 616 and the landing width 612 decreases from the inlet to middle, and again from the middle to the outlet.

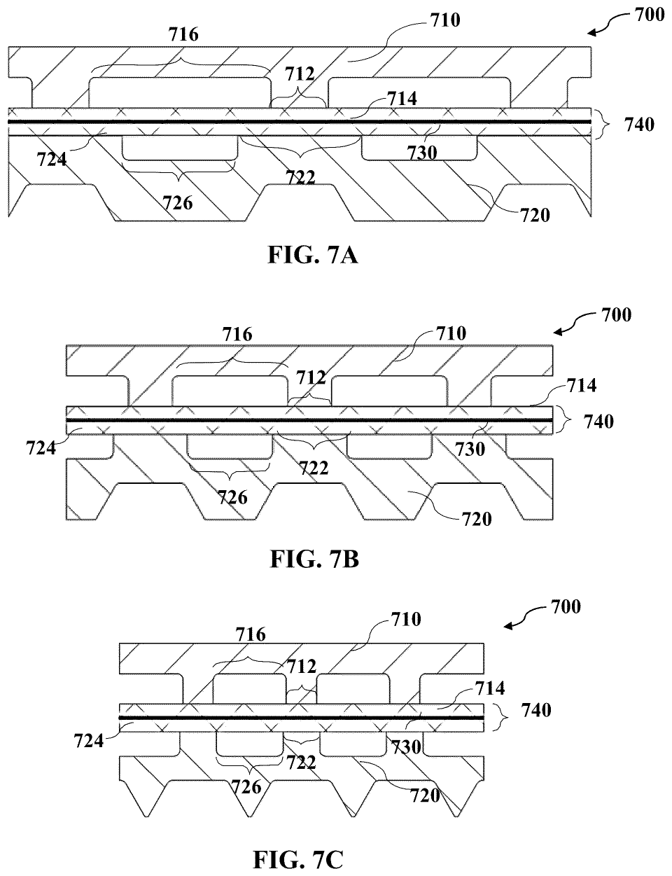

FIGS. 7A, 7B and 7C are cross-sectional views of a portion of a fuel cell 700 having a Flow Field D on the upper flow field plate. Fuel cell 700 includes a membrane electrode assembly 740 interposed between a first (upper) flow field plate 710 and a second (lower) flow field plate 720. Membrane electrode assembly 740 includes ion exchange membrane 730 interposed between two electrodes, 714 and 724. First flow field plate 710 has a plurality of landings with width 712 and channels width 716, and second flow field plate 720 has a plurality of landings with width 722 and channels with width 726.

FIG. 7A, shows a cross-section of fuel cell 700 near the inlet. FIG. 7B, shows a cross-section of fuel cell 700 near the middle. FIG. 7C, shows a cross-section of fuel cell 700 near the outlet. As is apparent from these illustrations, on the first flow field plate 710 the channel width 716 and the landing width 712 decreases from the inlet to middle, and again from the middle to the outlet.

The channel width of the flow fields in each of these embodiments illustrated in FIGS. 4-7 can be described by equation (1):

$$w = {w}_{0} \times {e}^{[ \frac{- ln ( \frac{λ}{λ - 1} ) \times l}{{l}_{m}} ]} \qquad ( 1 )$$

where w is the channel width, wo is the channel width at the reactant inlet, λ is the (design) stoichiometry, l is a selected position along the channel length, and lₘ is the channel length.

Flow Fields B and C are similar to one another. Flow field B was designed by setting the landing width based on a scaled value of the local channel width at each point along the channel (to achieve substantially constant LCWR), whereas Flow Field C was designed by scaling the landing width based on a predicted local oxygen concentration along the length of the channel (for substantially constant Landing Area Activity).

FIG. 8 is a graph illustrating channel width and landing width as a function of channel length for Flow Field A.

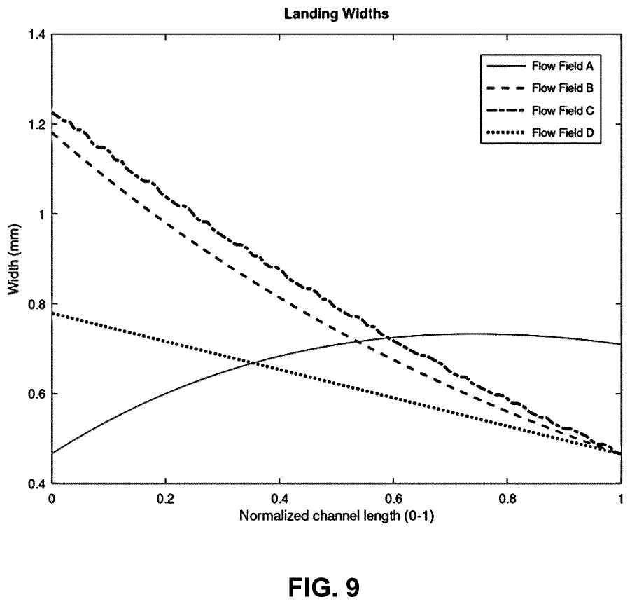

FIG. 9 is a graph illustrating landing width as a function of (normalized) channel length for each of the Flow Fields A-D. This shows the variation in landing width along the length of the channel, rather than illustrating the landing width at just three locations along the channel as is the case in FIGS. 4-7. In contrast to Flow Field A, in Flow Fields B, C and D the width of the landing decreases as one moves along the flow field from inlet to outlet. In a conventional flow field with channels of constant width, typically the landing widths are also constant (see for example, FIG. 3A).

To better illustrate the effect landing width can have on a fuel cell, the fuel cells with four flow fields Flow Field A, Flow Field B, Flow Field C, and Flow Field D were modeled as discussed below.

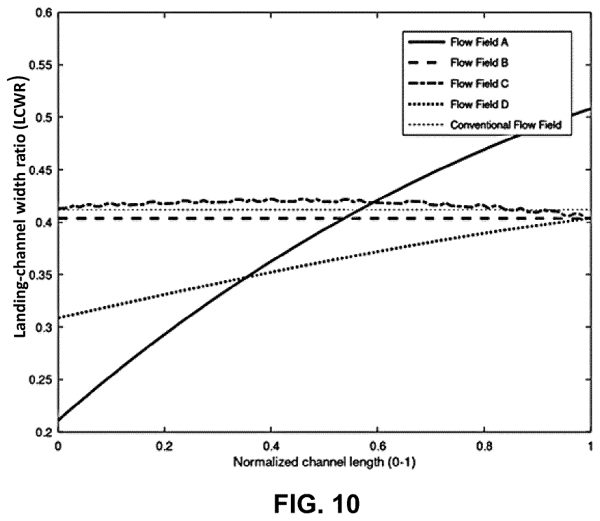

FIG. 10 is a graph illustrating landing-channel width ratio (LCWR) as a function of channel length for Flow Fields A-D. In Flow Fields B-D, the LCWR stays relatively constant compared to Flow Field A at a given distance down the length of the channel from the inlet.

In Flow Field A the coefficient of variation of the LCWR is 0.23. In Flow Field B the coefficient of variation of the LCWR is 0.00. In Flow Field C the coefficient of variation of the LCWR is 0.01. In Flow Field D the coefficient of variation of the LCWR is 0.08.

In some embodiments, the Landing Area Fraction (LAF) is substantially uniform across the flow field region of a flow field plate (where the flow field region is the region of the plate in which there are reactant channels). In some such embodiments, the LAF varies less than 15% across the flow field region of a flow field plate. In some such embodiments, the LAF varies less than 10% across the flow field region of a flow field plate. In some such embodiments, the LAF varies less than 5% across the flow field region of a flow field plate. In some embodiments, the LAF is uniform across the flow field region of a flow field plate.

In some embodiments, the LCWR is substantially constant along the length of the flow channel(s) on a surface of a flow field plate. In some such embodiments, the landing-channel width ratio (LCWR) varies less than 15% along the length of the flow channel(s) on a surface of a flow field plate. In some such embodiments, the LCWR varies less than 10% along the length of the flow channel(s) on a surface of a flow field plate. In some such embodiments, the LCWR varies less than 5% along the length of the flow channel(s) on a surface of a flow field plate. In some embodiments, the LCWR is constant along the length of the flow channel(s) on a surface of a flow field plate.

Landing Pressure is the pressure exerted on the GDL by the landing when the fuel cell is compressed. Landing Pressure varies as a function of the landing-channel width ratio (LCWR). A region of a landing with a smaller LCWR experiences a higher contact pressure compared to a region with a larger LCWR for the same force.

$$Local Landing Pressure = \frac{Cell LAF}{L CWR \times overall Cell Landing Pressure}$$

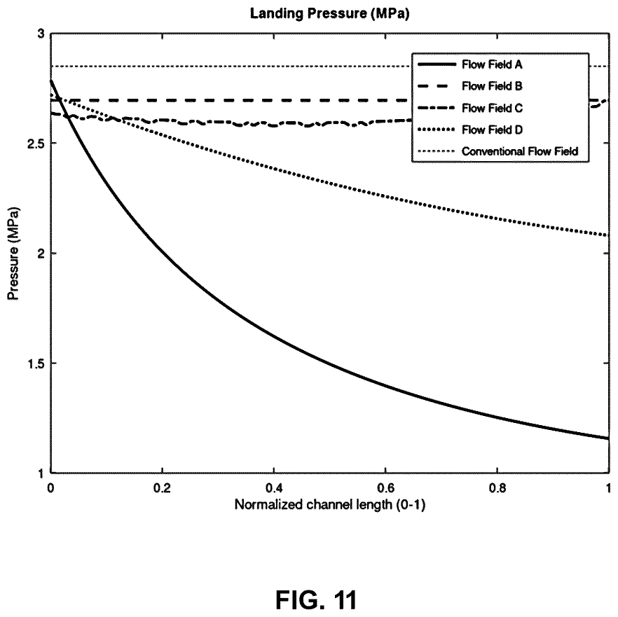

FIG. 11 is a graph illustrating contact pressure at the landing (Landing Pressure) as a function of landing or adjacent channel length for Flow Fields A-D. In Flow Fields B-D the Landing Pressure stays relatively constant compared to Flow Field A.

In Flow Field A the coefficient of variation of the Landing Pressure is 0.27. In Flow Field B the coefficient of variation of the Landing Pressure is 0.00. In Flow Field C the coefficient of variation of the Landing Pressure is 0.01. In Flow Field D the coefficient of variation of the Landing Pressure is 0.08.

In some embodiments, the Landing Pressure is substantially uniform across the flow field region of a flow field plate. In some such embodiments, the Landing Pressure varies less than 15% across the flow field region of a flow field plate. In some such embodiments, the Landing Pressure varies less than 10% across the flow field region of a flow field plate. In some such embodiments, the Landing Pressure varies less than 5% across the flow field region of a flow field plate. In some embodiments, the Landing Pressure is uniform across the flow field region of a flow field plate.

One benefit of keeping the contact pressure between the landing and the GDL uniform, or at least more uniform across a fuel cell or fuel cell active area, is that the electrical contact resistance between the landing and GDL is then generally uniform, or at least more uniform. Also, in at least some embodiments, if the contact pressure is more uniform, the thermal contact resistance generally is more uniform across the fuel cell.

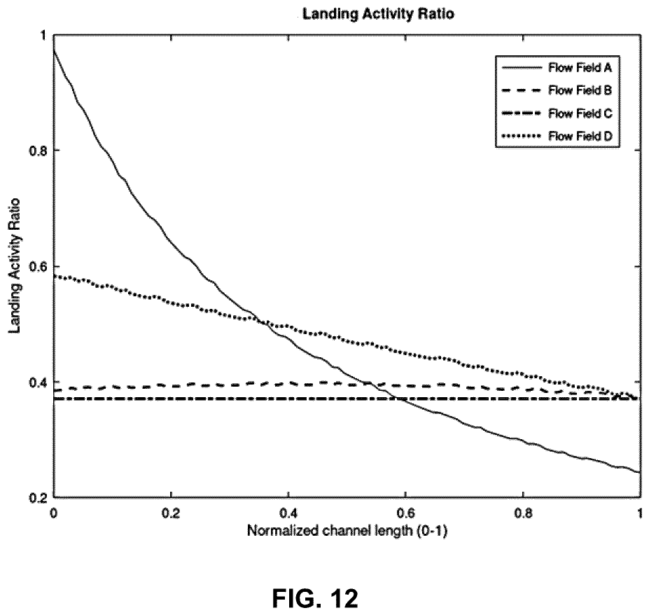

FIG. 12 is a graph illustrating Landing Activity Ratio as a function of channel length for Flow Fields A-D. In Flow Fields B-D the Landing Activity Ratio is more uniform across the flow field region than in Flow Field A.

$$local Landing Activity Ratio = \frac{local Reactant Concentration}{local Landing Width}$$

The change in reactant concentration along a reactant flow field channel can be calculated based on a thermofluidic model of the fuel cell that accounts for reactant consumption due to the fuel cell electrochemical reaction, pressure drop due to friction of the gas moving through the channel, and change in composition of the gas in the channel due to the production of water. Based on the initial reactant concentration and the change in reactant concentration, the local reactant concentration can be determined.

In Flow Field A the coefficient of variation of the Landing Activity Ratio is 0.41. In Flow Field B the coefficient of variation of the Landing Activity Ratio is 0.02. In Flow Field C the coefficient of variation of the Landing Activity Ratio is 0.00. In Flow Field D the coefficient of variation of the Landing Activity Ratio is 0.13.

In some embodiments, the Landing Activity Ratio is substantially uniform across the flow field region of a flow field plate. In some such embodiments, the Landing Activity Ratio varies less than 15% across the flow field region of a flow field plate. In some such embodiments, the Landing Activity Ratio varies less than 10% across the flow field region of a flow field plate. In some such embodiments, the Landing Activity Ratio varies less than 5% across the flow field region of a flow field plate. In some embodiments, the Landing Activity Ratio is uniform across the flow field region of a flow field plate.

In at least some embodiments, the ability of reactants to diffuse under the landing area varies down the length of the channel as a result of changing local availability of the reactant which is consumed. In at least some embodiments, varying the landing width can, at least in part, compensate for the reduced availability of the reactant along the length of the cell.

For example, the ability of the reactant to access catalyst beneath the landings can be diminished if the landings are wide, because of the additional in-plane diffusion distance required for reactants to travel from a channel to that portion of the catalyst layer. Keeping the width of the landing consistent in proportion to channel reactant concentration can help compensate for this.

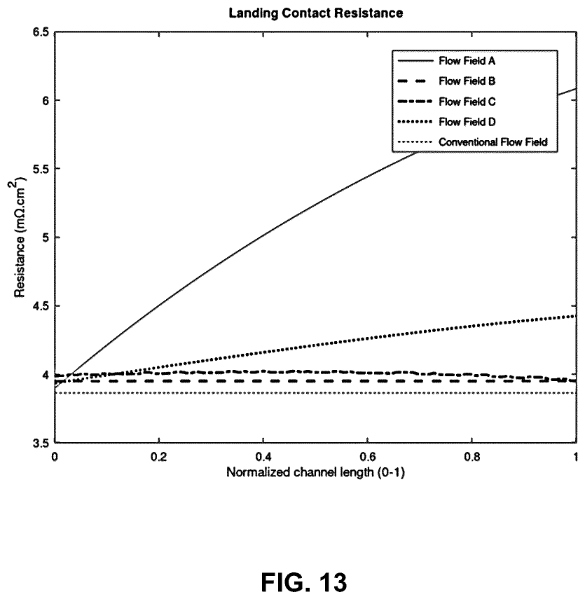

FIG. 13 is a graph illustrating Landing Contact Resistance as a function of channel length for Flow Fields A-D. In Flow Fields B-D the Landing Contact Resistance stays relatively constant compared to Flow Field A. In some embodiments, by keeping the electrical contact resistance uniform, or at least more uniform, between the landing and GDL across the fuel cell active area, a more uniform reaction and current density can be achieved.

contactResistance=localLandingPressure×interfaceResistanceUnderCompression

In Flow Field A the coefficient of variation of the Landing Contact Resistance is 0.12. In Flow Field B the coefficient of variation of the Landing Contact Resistance is 0.00. In Flow Field C the coefficient of variation of the Landing Contact Resistance is 0.01. In Flow Field D the coefficient of variation of the Landing Contact Resistance is 0.04.

In some embodiments, the Landing Contact Resistance is substantially uniform across the flow field region of a flow field plate. In some such embodiments, the Landing Contact Resistance varies less than 0.10% across the flow field region of a flow field plate. In some such embodiments, the Landing Contact Resistance varies less than 0.05% across the flow field region of a flow field plate. In some such embodiments, the Landing Contact Resistance varies less than 0.01% across the flow field region of a flow field plate. In some embodiments, the Landing Contact Resistance is uniform across the flow field region of a flow field plate.

In some embodiments of fuel cell assemblies with reactant channels that vary in width along at least a portion of their length, the flow field can be designed so that the LCWR is substantially constant along the landing or adjacent channel length, and/or so that the LAF is substantially uniform across the active area of the fuel cell or across the flow field region of a flow field plate, and/or so that the contact pressure between the landings and the GDL is substantially uniform across the active area of the fuel cell or across the flow field region of a flow field plate, and/or so that the Landing Activity Ratio is substantially uniform across the active area of the fuel cell or across the flow field region of a flow field plate and/or so that the Landing Contact Resistance is substantially uniform across the active area of the fuel cell or across the flow field region of a flow field plate. In other embodiments, the flow field can be designed so that various ones of these conditions are met in different regions. For example, a flow field can be designed so that the LCWR is substantially constant along a portion of the landing or adjacent channel length, and so that the Landing Activity Ratio is substantially uniform along another portion of the landing or adjacent channel length.

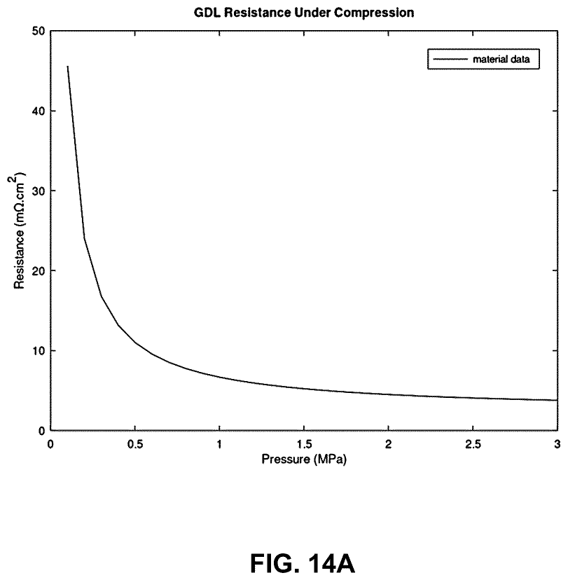

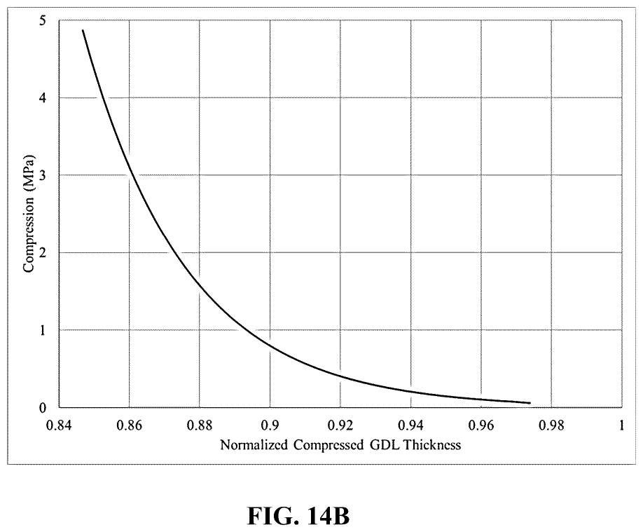

FIG. 14A is a graph illustrating GDL through-plane electrical resistance under compression for a representative GDL. GDL through-plane electrical resistance as a function of compression is a material property specific to each GDL and is typically measured ex situ. The electrical contact resistance for a GDL/landing interface is a non-linear function of the contact pressure.

FIG. 14B is a graph illustrating normalized compressed GDL thickness as a function of compression force applied to the GDL. It illustrates that as the GDL is compressed and its thickness is reduced, it becomes more difficult (and more force is required) to compress and compact it further. Consideration of the combination of GDL through-plane electrical resistance under compression (FIG. 14A) and GDL thickness under compression (FIG. 14B) can be used to design fuel cells that simultaneously reduce or minimize electrical resistance while not exceeding contact pressures that can mechanically fracture the GDL and/or eliminate the requisite porosity for water and reactant management. The GDL thickness under compression data can also be used to design the seals such that the mechanical load is predominantly transferred to the active area of the fuel cells in a stack.

Flow fields A-D have channels with widths that vary along their length. However, aspects of what is disclosed herein could be utilized with flow fields with channels with widths and/or cross-sectional areas that vary along just a portion of the channel length, or with flow fields with channels with widths and/or cross-sectional areas that are constant along their length. In some embodiments, the channel depth can be constant and, in some embodiments, it can vary along at least a portion of the channel length.

In embodiments of the fuel cells described herein, the flow fields can comprise other features besides elongate channels and landings. For example, features such as posts, pins, columns, microchannels, or the like can be incorporated between channel walls to add to the landing area at a given cross-section. In some embodiments, landings that have a T-shape in cross-section along at least a portion of their length can be used. This can be beneficial where the channel width is wide and the GDL can benefit from additional support, such as the inlet or transition areas leading into or out of the fuel cell active area.

### Variable Compression Systems and Methods

In some embodiments of a fuel cell or fuel cell stack, it is beneficial to create uniform (or more uniform) contact pressure at the GDL-to-plate landing interface across a flow field plate. This can enhance the performance and/or durability of a fuel cell. As described above, in some fuel cells a tendency for non-uniform landing pressure can be partially or fully compensated by adjusting the flow field design (e.g. the choice of landing geometry for a particular channel geometry).

In fuel cells where a particular flow field plate shape and/or flow field design (e.g. landing and channel geometry) are such that with the application of substantially uniform compressive force across the plate there is a non-uniform contact pressure across the flow field plates, one approach is to utilize a fuel cell stack compression system that applies a non-uniform compressive force across the plate in order to make the contact pressure more uniform across the flow field plates. For example, such a compression system could apply less force to a region or regions of the plate where the contact pressure would otherwise be high, and more force to a region or regions of the plate where the contact pressure would otherwise be low.

When attempting to create uniform contact pressure by using non-uniform compression techniques, variations in contact pressures which can result from diminishing active areas can also be considered. For example, sometimes in fuel cells where the width of the channels and/or landings varies along at least a portion of the channel length, non-rectangular flow field plates are used. For example, isosceles trapezoidal plates or trapezoidal plates where only two sides of the plate have the same length can be used. When such plates are used with a conventional compression system, the fuel cells may not be uniformly compressed.

In some embodiments, for example, in fuel cell stacks where there is essentially co-flow of oxidant and fuel (and optionally coolant) across the flow field plates in the stack, the compression system can apply a compressive force that varies in the direction of reactant flow. In some embodiments the compressive force decreases in the direction of reactant flow.

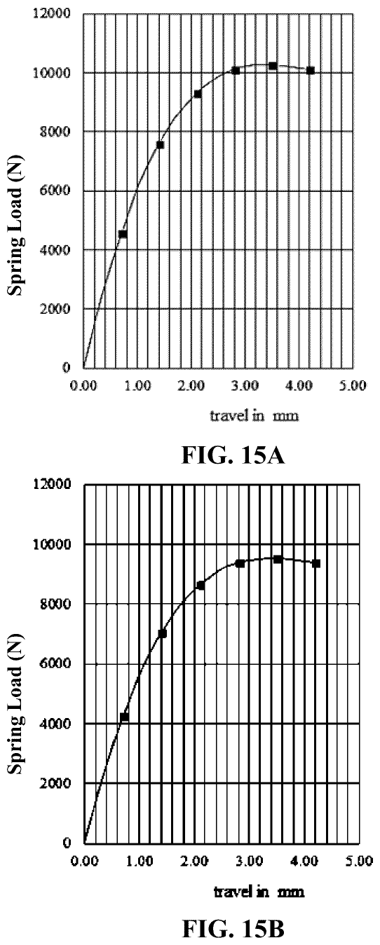

FIG. 15A and FIG. 15B are graphs illustrating the spring characteristics of two different types of springs that can be used in some embodiments of a non-uniform compression system. As illustrated, the spring curves flatten out near the end of the springs' maximum travel. As a result, in areas where the springs are expected to be loaded, they deflect the same amount. Even when the fuel cell stack compresses further, each spring still applies substantially the same force as when initially installed. Even though each spring may travel the same distance, the force applied is close to the original force, and each spring may maintain a different applied force compared to another spring with a different force for the same displacement. The spring illustrated in FIG. 15A is stiffer than the one shown in FIG. 15B and has a higher force at higher deflections.

In some embodiments, a spring, such as the one illustrated in FIG. 15A can be used towards the inlet of the stack, and a spring, such as the one illustrated in FIG. 15B can be used toward the outlet. In at least some embodiments, this allows different compressive forces to be applied to different regions of a flow field plate by the stack compression system, for example, to achieve substantially uniform contact pressure for flow fields that would otherwise have non-uniform contact pressure (for example, flow fields where the LAF is different in different regions of the plate).

In some embodiments, a plurality of springs can be used in a stack compression system. In some embodiments, multiple compression springs with different stiffnesses or spring rates can be utilized in a stack compression system. In some embodiments, springs can be placed in various positions across the area of the fuel cell. In some embodiments, springs with larger interior diameters can be used for fuel cell stacks with larger active areas. In some embodiments, variable compression springs (with increasing force rate with increasing deflection) can be used. In some embodiments disc springs can be used.

In some embodiments, a fuel cell stack compression system can comprise a plurality of straps having different tensions.

In some embodiments, a fuel cell stack compression system can comprise a plurality of tie rods having different tensions. In some embodiments, different ones of the tie rods have different geometries.

In some embodiments, a fuel cell stack compression system can comprise end-plate hardware that is segmented. For example, rather than comprising a pair of end-plates that are co-extensive with the fuel cell flow field plates (or extend beyond the perimeter of the stacked flow field plates), the end-plate(s) at one or both ends of the fuel cell stack can be segmented into at least two parts, each part overlying a different region of the stacked flow field plates. For example, in some embodiments a fuel cell stack compression system comprises end-plate hardware that includes two end-plate segments that are positioned side-by-side at one end of a fuel cell stack.

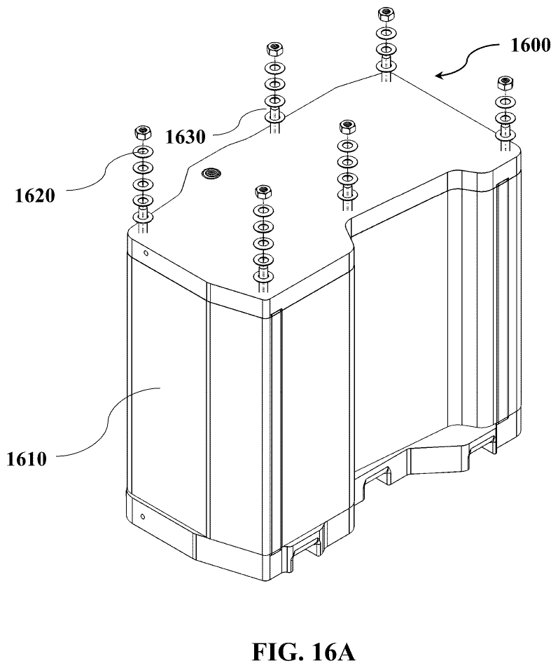

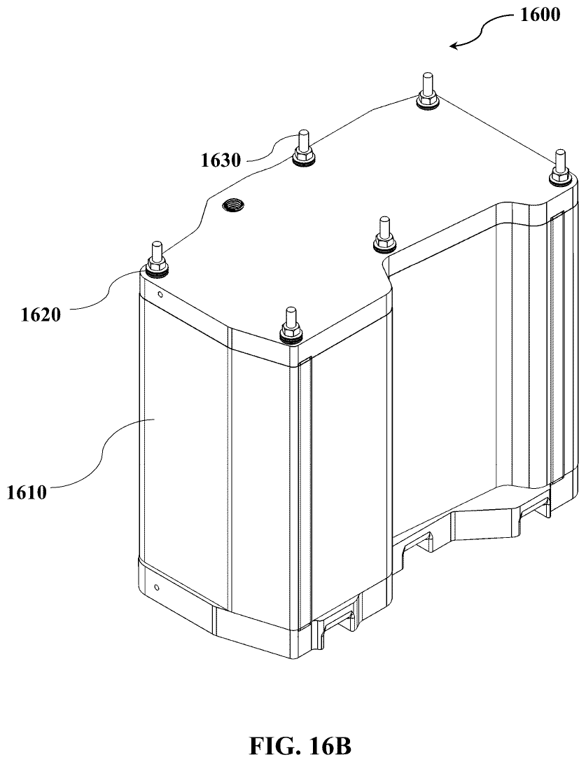

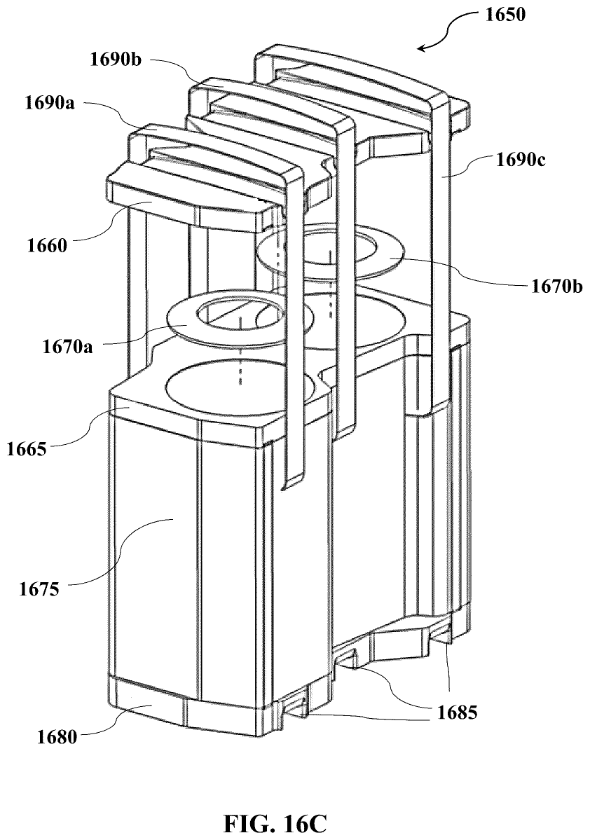

In some embodiments, such as the one shown in FIG. 16A and 16B, various washers 1620 in combination with tie-rods 1630 can be utilized with fuel cell stack assembly 1600 to impose different degrees of compressive force to different regions of the fuel cells in the fuel cell stack 1610. In some embodiments, more washers 1620 can be placed in areas where greater compressive force is desired. In some embodiments, washers 1620 are spring washers.

In some embodiments, such as fuel cell stack assembly 1650 shown in a partially exploded perspective view in FIG. 16C, a stack compression system comprises an upper end-plate assembly comprising a pair of plates 1660 and 1665 with a pair of disc springs 1670a and 1670b positioned in between them. Fuel cells in fuel cell stack 1675 are interposed between endplates 1665 and 1680. Compression straps 1690a, 1690b and 1690c extend over plate 1660 and are secured at each end to attachment points 1685 on a lower end-plate 1680, and cooperate with the upper end-plate assembly and lower end-plate 1680 to apply compressive force to fuel cell stack 1675. In some embodiments, disc springs 1670a and 1670b can have different spring rates so that different degrees of compressive force are applied to different regions of the fuel cells in fuel cell stack 1675 for the same displacement of the disc springs. The tension in straps 1690a, 1690b and 1690c can also be selected so that different degrees of compressive force are applied to different regions of the fuel cells in fuel cell stack 1675. In some embodiments, there can be more than two disc springs arranged side-by-side, and/or there maybe two or more stacks or sets of disc springs arranged side-by-side at one or both ends of the fuel cell stack. In some embodiments, the number and arrangement of compression straps or bands can differ from the illustrated embodiment, and/or they can encircle fuel cell stack and end-plates rather than being attached to the end-plates.

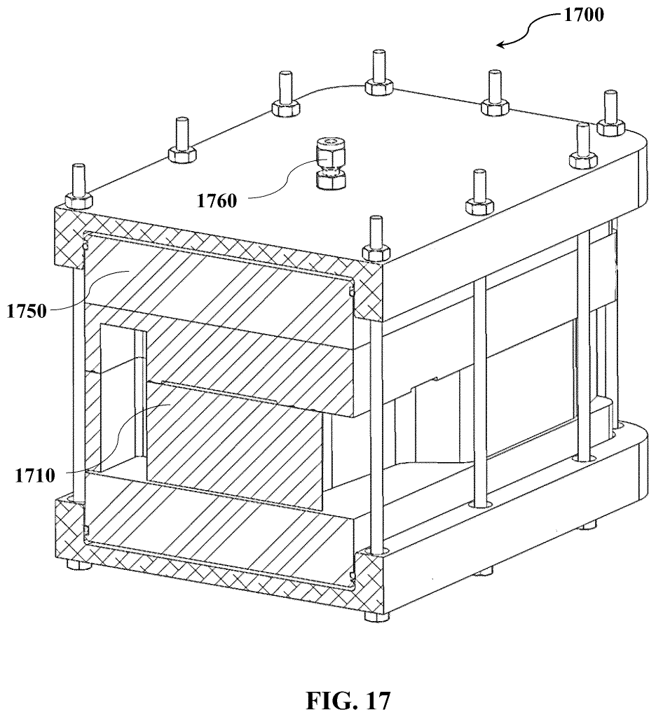

In some embodiments, such as the stack assembly 1700 shown in a partial cross-sectional view in FIG. 17, a hydraulic bladder and/or cylinder-piston arrangement can be utilized to apply compression to a fuel cell stack 1710. In some embodiments, hydraulic fluid can be supplied to piston 1750 via inlet 1760. In some embodiments, hydraulic fluid can be supplied to one or more other pistons (not shown in FIG. 17) having different areas, so that a non-uniform compressive force is applied across the fuel cells in fuel cell stack 1710.

Compression system elements, such as those described above (for example, springs, tie rods, straps, pistons, bladders, layered and/or segmented end-plates) and other suitable elements can be configured in various combinations to provide a compression system that can be used to apply a non-uniform compressive force across the fuel cells in a fuel cell stack.

In some embodiments of fuel cell assemblies with reactant channels that vary in width along at least a portion of their length, the compression system can be designed in combination with the flow field, so that the contact pressure between the landings and the GDL is substantially uniform across the active area of the fuel cell or across the flow field region of a flow field plate, and/or so that the Landing Activity Ratio is substantially uniform across the active area of the fuel cell or across the flow field region of a flow field plate and/or so that the Landing Contact Resistance is substantially uniform across the active area of the fuel cell or across the flow field region of a flow field plate. In other embodiments, the compression system can be designed in combination with the flow field so that various ones of these conditions are met in different regions.

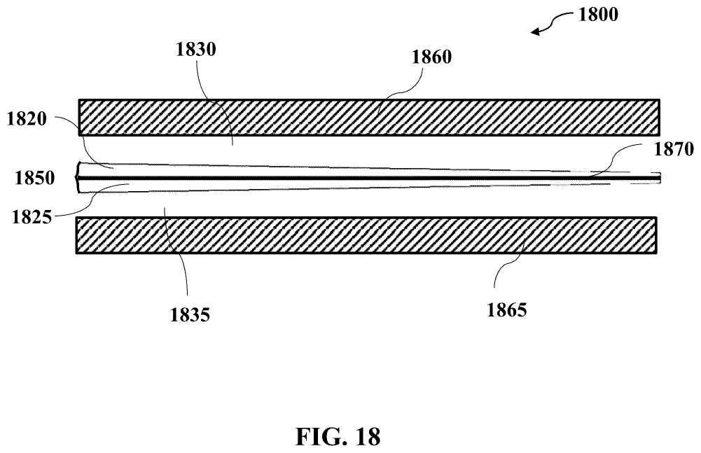

FIG. 18 shows a simplified, cross-sectional view of a fuel cell assembly 1800 that comprises wedge-shaped gas diffusion layers, 1820 and 1825 (having variable thickness) on the cathode and anode side. The wedge-shaped GDL has different compressibility in the thicker region than in the thinner region. Fuel cell assembly 1800 includes cathode channel 1830 and anode channel 1835, the channels formed in a respective cathode flow field plate 1860 and anode flow field plate 1865. Membrane electrode assembly 1850 is interposed between cathode flow field plate 1860 and anode flow field plate 1865. Membrane electrode assembly 1850 can include ion exchange membrane 1870 interposed between the two GDLs 1820 and 1825. An electrocatalyst layer (not shown in FIG. 18) is disposed between each GDL and the ion exchange membrane 1870. Because the GDLs have a thickness that varies across their area—in this example, decreasing from left to right along the direction of the channels 1830 and 1835—they can counteract a varying contact pressure caused by, for example, varying land widths across the flow field. The wedge-shaped GDL can be compressed to a different degree in different regions to achieve a uniform thickness. For instance, if a particular flow field tends to have a lower contact pressure toward the outlet (e.g. because of a higher LAF) and therefore provides a lower compressive force on the GDL, then the GDL can be made to be compressed more toward the outlet to offset what would only be a contribution from the landing force toward the outlet.

In some embodiments, the volume and geometry of the seal system can be changed as a function of seal force to balance seal reaction force from inlet to outlet, since the seal reaction force increases with increases in compression. In some embodiments, seal reaction load under compression varies based on the volume and shape of the seal. A wider or shallower seal may resist deflection under higher compressive loads than a seal that is taller or narrower. In some embodiments, load-balancing seals can be used. In at least some embodiments, load-balancing seals act as a local reaction force.

What is desirable or optimal in terms of fuel cell stack compression can change depending on whether the fuel cell stack is in a passive or an active state. For example, in dynamic operation, there can be transients in gas pressure, pressure differential across the MEA between the anode and the cathode, pressure drop along the channels, and relative humidity that can affect what is desirable in terms of stack compression (e.g. actual compression force and compression force distribution).

In some embodiments, the fuel cell flow field or fuel cell stack compression system, or the combination of both, can be designed to achieve a desired contact pressure distribution across the fuel cells when the stack is assembled and compressed prior to operation (e.g. without reactant and coolant). In some embodiments, the fuel cell flow field or fuel cell stack compression system, or the combination of both, can be designed to achieve a desired contact pressure distribution across the fuel cells when the fuel cell stack is in operation. In some embodiments, the stack compression system is adjustable and can be configured and adjusted to achieve a desired contact pressure distribution across the fuel cells under different operating conditions, or prior to and during operation.

In operation, even conventional fuel cells utilizing channels with constant widths and substantially constant LCWR along their length (and/or uniform LAF over the active area) can see contact pressure vary across the active area (or along the length of the landings, for example, due to variations fluid pressures, relative humidity and differential pressure which arise along the channels during operation. In some embodiments, fuel cells with channel widths that vary along at least a portion of their length tend to exhibit more uniform conditions across the plates when the fuel cell is in operation than conventional fuel cells. However, this is not always the case. Contact pressure can vary across the active area in operation, even if it is fairly uniform at the time the stack is assembled. In either case, embodiments of a fuel cell stack compression system that applies a non-uniform compressive force to the fuel cells can be used to fully or partially compensate for variations in contact pressure that are expected to occur during operation of the stack under its anticipated operating conditions.

In fuel cells where the width of the channels varies along at least a portion of the channel length, the selection of the dimensions and geometry of the landings between the channels can affect contact pressure distribution (as discussed above) and/or other parameters such as, for example, reactant access beneath the landings, electrical contact resistance and current collection, thermal contact resistance and thermal management. Similarly, the compression system can affect these parameters. Although in some embodiments the flow field and/or compression system can be designed to improve or optimize for one particular parameter that can affect fuel cell performance, in other embodiments the flow field or compression system (or these in combination) can be designed to achieve acceptable levels across several competing parameters by making appropriate trade-offs.

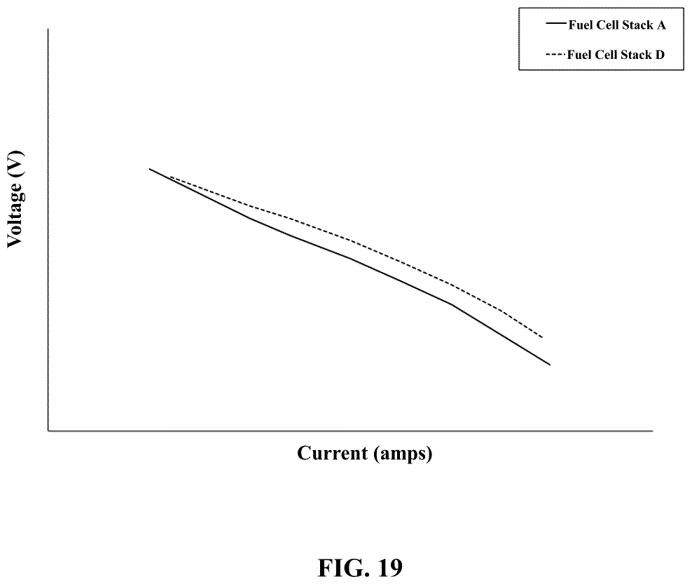

FIG. 19 illustrates the performance of a fuel cell stack (Stack A) comprising fuel cells with Flow Field A with the performance of a fuel cell stack (Stack D) comprising fuel cells with Flow Field D. The differences between the channel/landing geometry in Flow Field A and Flow Field D are described in reference to FIGS. 9-12. The stacks were operated under the same conditions, employed the same membrane electrode assemblies (MEAs), and the outer dimensions of the flow field plates were the same in both stacks. Both stacks had the same number of cell stacks. The comparative stack voltage (volts) versus current (amps) plots in FIG. 19 show that Stack D (using cells with Flow Field D) provided improved performance relative to Stack A (using cells with Flow Field A). The cell internal resistance for Stack D was found to be 14.3% lower for Stack D than Stack A.

Throughout the following description, specific details are set forth in order to provide a more thorough understanding of the invention. However, the invention may be practiced without these particulars. In other instances, well-known elements have not been shown or described in detail to avoid unnecessarily obscuring the invention. Accordingly, the specification and drawings are to be regarded in an illustrative, rather than a restrictive sense.

Unless the context clearly requires otherwise, throughout the description and the claims:
“comprise”, “comprising”, and the like are to be construed in an inclusive sense, as opposed to an exclusive or exhaustive sense; that is to say, in the sense of “including, but not limited to”;
“connected”, “coupled”, or variants thereof, mean connection or coupling, either direct or indirect, permanent or non-permanent, between two or more elements; the coupling or connection between the elements can be physical, logical, or a combination thereof;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms.

Words that indicate directions such as “vertical”, “transverse”, “horizontal”, “upward”, “downward”, “forward”, “backward”, “inward”, “outward”, “vertical”, “transverse”, “left”, “right”, “front”, “back”, “top”, “bottom”, “below”, “above”, “under”, and the like, used in this description and any accompanying claims (where present), depend on the specific orientation of the apparatus described and illustrated. The subject matter described herein may assume various alternative orientations. Accordingly, these directional terms are not strictly defined and should not be interpreted narrowly.

Where a component (e.g. a flow field plate, gas diffusion layer, spring, assembly, device, etc.) is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which perform the function of the described component.

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

While particular elements, embodiments and applications of the present invention have been shown and described, it will be understood, that the invention is not limited thereto since modifications can be made by those skilled in the art without departing from the scope of the present disclosure, particularly in light of the foregoing teachings.

What is claimed is:

1. A fuel cell assembly comprising a unit cell, wherein said unit cell comprises:
a membrane electrode assembly comprising a proton exchange membrane interposed between a first electrode and a second electrode, said first electrode comprising a first gas diffusion layer and a first catalyst layer, and said second electrode comprising a second gas diffusion layer and a second catalyst layer, said first and second catalyst layers defining an active area of said unit cell;
a first flow field plate having a first surface adjacent to said first gas diffusion layer, said first flow field plate comprising a plurality of first channels formed in said first surface thereof, adjacent ones of said first channels separated by landings, and said first channels having a first channel length, and said first channels having a width that varies along at least a portion of said first channel length; and
a second flow field plate adjacent to said second electrode,
wherein, when a substantially uniform compressive force is applied to said unit cell to urge said first and second flow field plates toward one another, a contact pressure between said first gas diffusion layer and said landings of said first flow field plate is substantially uniform across said active area of said unit cell.

2. The fuel cell assembly of claim 1 wherein a landing-channel width ratio (LCWR) is substantially constant along said first channel length.

3. The fuel cell assembly of claim 1 wherein a landing area fraction (LAF) on said first surface of said first flow field plate is substantially uniform across said active area of said unit cell.

4. The fuel cell assembly of claim 1, wherein said second flow field plate has a first surface adjacent to said second gas diffusion layer, and said second flow field plate comprises a plurality of second channels formed in said first surface thereof, adjacent ones of said second channels separated by landings, said second channels having a second channel length, and said second channels having a width that varies along at least a portion of said second channel length, and
wherein, when said substantially uniform compressive force is applied to said unit cell to urge said first and second flow field plates toward one another, a contact pressure between said second gas diffusion layer and said landings of said second flow field plate is substantially uniform across said active area of said unit cell.

5. The fuel cell assembly of claim 1, wherein said width varies along the entire length of said first channels.

6. The fuel cell assembly of claim 1, wherein said width decreases along at least said portion of said first channel length in a direction of reactant flow.

7. The fuel cell assembly of claim 1, wherein said width decreases along at least said portion of said first channel length in a direction of reactant flow according to a natural exponential function.

8. The fuel cell assembly of claim 1, wherein said active area is trapezoidal.

9. A fuel cell assembly comprising a unit cell, wherein said unit cell comprises:
a membrane electrode assembly comprising a proton exchange membrane interposed between a first electrode and a second electrode, said first electrode comprising a first gas diffusion layer and a first catalyst layer, and said second electrode comprising a second gas diffusion layer and a second catalyst layer, said first and second catalyst layers defining an active area of said unit cell;
a first flow field plate having a first surface adjacent to said first gas diffusion layer, said first flow field plate comprising a plurality of first channels formed in said first surface thereof, adjacent ones of said first channels separated by landings, and said first channels having a first channel length;
a second flow field plate adjacent to said second electrode; and
a compression system urging said first and second flow field plates toward one another and applying non-uniform compressive force across said active area of said unit cell, wherein a contact pressure between said first gas diffusion layer and said landings of said first flow field plate is substantially uniform across said active area of said unit cell.

10. The fuel cell assembly of claim 9 wherein a landing-channel width ratio (LCWR) varies along at least a portion of said first channel length.

11. The fuel cell assembly of claim 9 wherein a landing area fraction (LAF) on said first surface of said first flow field plate varies across said active area of said unit cell.

12. The fuel cell assembly of claim 9 wherein said first channels have a width that varies along at least a portion of said first channel length.

13. The fuel cell assembly of claim 12, wherein said second flow field plate has a first surface adjacent to said second gas diffusion layer, and said second flow field plate comprises a plurality of second channels formed in said first surface thereof, adjacent ones of said second channels separated by landings, said second channels having a second channel length, and said second channels having a width that varies along at least a portion of said second channel length,
wherein a contact pressure between said second gas diffusion layer and said landings of said second flow field plate is substantially uniform across said active area of said unit cell.

14. The fuel cell assembly of claim 12, wherein said width decreases along at least said portion of said first channel length in a direction of reactant flow.

15. The fuel cell assembly of claim 12, said width decreases along at least said portion of said first channel length in a direction of reactant flow according to a natural exponential function.

16. The fuel cell assembly of claim 9, wherein said active area is trapezoidal.

17. The fuel cell assembly of claim 9, wherein said fuel cell assembly comprises a fuel cell stack comprising a plurality of said unit cells, and said compression system comprises a pair of end-plate assemblies, said fuel cell stack interposed between said pair of end-plate assemblies, wherein at least one of said end-plate assemblies comprises a plurality of plate segments positioned side-by-side at one end of said fuel cell stack.

18. The fuel cell assembly of claim 9, wherein said fuel cell assembly comprises a fuel cell stack comprising a plurality of said unit cells, and said compression system comprises a pair of end-plate assemblies, said fuel cell stack interposed between said pair of end-plate assemblies, at least one of said end-plate assemblies comprising a plurality of plate segments positioned side-by-side at one end of said fuel cell stack, wherein each of said plurality of plate segments comprises a spring set with a different force-displacement characteristic, each of said plate segments and its associated spring set exerting a different compressive force on said fuel cell stack.

19. The fuel cell assembly of claim 9, wherein said fuel cell assembly comprises a fuel cell stack comprising a plurality of said unit cells, and said compression system comprises first and second end-plate assemblies and a first spring assembly and a second spring assembly positioned side-by-side and interposed between said first end-plate assembly and said fuel cell stack, said first spring assembly overlying a first portion of said active area of said unit cells and said second spring assembly overlying a second portion of said active area of said unit cells, wherein said first spring assembly has a different force-displacement characteristic from said second spring assembly.

20. A method for reducing contact pressure variation between components in a solid polymer fuel cell assembly during operation of said solid polymer fuel cell assembly to produce electrical power, said method comprising applying a non-uniform compressive force across an active area of said solid polymer fuel cell assembly to at least partially compensate for variations in contact pressure caused by operation of said solid polymer fuel cell assembly.
